(19) United States
(12) Patent Application Publication
(10) Pub. No.: US 2012/0182103 A1
(43) Pub. Date: Jul. 19, 2012

(54) MAGNET AND METHOD OF MANUFACTURING OF THE SAME

(75) Inventor: Kenji MIYABARA, Nagano (JP)

(73) Assignee: SHINANO KENSHI CO., LTD., Ueda-shi (JP)

(21) Appl. No.: 13/346,036

(22) Filed: Jan. 9, 2012

(30) Foreign Application Priority Data
Jan. 17, 2011 (JP) 2011-007340
Nov. 29, 2011 (JP) 2011-260978

(51) Int. Cl. H01F 7/02; H01F 41/02

(52) U.S. Cl. 335/302; 427/558

(57) ABSTRACT

A magnet includes: a magnet main body; and an ultraviolet curing resin layer formed on a surface of the magnet main body.

### CROSS-REFERENCE TO RELATED APPLICATION

This application is based upon and claims the benefit of priority of the prior Japanese Patent Application No. 2011-007340, filed on Jan. 17, 2011 and Japanese Patent Application No. 2011-260978, filed on Nov. 29, 2011, the entire contents of which are incorporated herein by reference.

### BACKGROUND

(i) Technical Field

The present invention relates to a magnet and a method of manufacturing of the same.

(ii) Related Art

As for a rust-proof treatment, there is conventionally known a method of coating on a surface of an object and forming a rust-proof film thereon. The coating method is known as electrodeposition coating (See Japanese Patent No. 3132130), powder coating, or splay coating. Such rust-proof treatment is applicable to a magnet in some cases.

In the electrodeposition coating, in order to fix coatings on the magnet, the magnet has to be heated and paints dried after coating. In the spray coating and the powder coating, a thermosetting resin is typically used as a coating. Likewise, in order to cure the thermosetting resin applied to the magnet main body, the magnet has to be heated after being coated. Such a magnet is heated in a heat-treatment furnace.

Since the magnet has to be heated for a predetermined period in such a way, the rust-proof treatment needs time. Further, the heat-treatment furnace has to be continuously operated for a predetermined period, thereby increasing the power consumption to operate the heat-treatment furnace. This increases the cost of the rust-proof treatment of the magnet.

### SUMMARY

It is therefore an object of the present invention to provide a magnet and a method of manufacturing the same with reduced cost of rust-proof treatment.

A magnet includes: a magnet main body; and an ultraviolet curing resin layer formed on a surface of the magnet main body.

The ultraviolet curing resin is cured by the radiation of the ultraviolet ray, whereby the ultraviolet curing resin is cured for a short period as compared to a case where the thermosetting resin is cured. Additionally, this suppresses an increase in the power consumption to operate the heat-treatment furnace. The rust-proof treatment is applied to the magnet by use of the ultraviolet curing resin, thereby reducing the cost of the rust-proof treatment.

A method of manufacturing a magnet includes: applying an ultraviolet curing resin on a magnet main body; and radiating an ultraviolet ray to the ultraviolet curing resin.

### BRIEF DESCRIPTION OF THE DRAWINGS

FIG. 1A is an external view of an example of a magnet according to the present embodiment, and FIG. 1B is a partially sectional view of the magnet;

FIGS. 2A to 2E are explanatory views of a first example of rust-proof treatment of the magnet;

FIGS. 3A to 3E are explanatory views of the first example of the rust-proof treatment of the magnet;

FIG. 4 is an explanatory view of a second example of the rust-proof treatment of the magnet;

FIG. 5 is an explanatory view of the second example of the rust-proof treatment of the magnet;

FIG. 6 is an explanatory view of the second example of the rust-proof treatment of the magnet;

FIG. 7 is an explanatory view of the second example of the rust-proof treatment of the magnet;

FIG. 8 is an explanatory view of the second example of the rust-proof treatment of the magnet;

FIG. 9 is an explanatory view of the second example of the rust-proof treatment of the magnet;

FIG. 10 is an explanatory view of the second example of the rust-proof treatment of the magnet; and

FIG. 11 is an explanatory view of the second example of the rust-proof treatment of the magnet.

### DETAILED DESCRIPTION

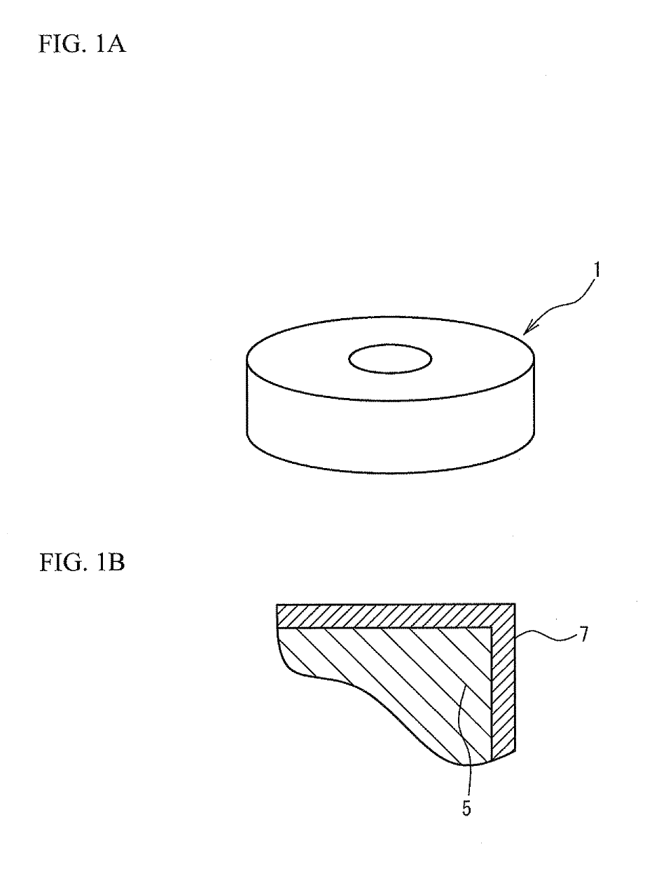

FIG. 1A is an external view of an example of a magnet according to the present embodiment. A magnet 1 has a cylindrical shape, but is not limited to such a shape. The magnet 1 may have, for example, a rod shape. For example, the magnet 1 may be used for an actuator or another device. FIG. 1B is a partially sectional view of the magnet 1. The magnet 1 includes a magnet main body 5, and an ultraviolet curing resin layer 7 formed on a surface of the magnet main body 5. The magnet main body 5 is an rare earth magnet. Specifically, the magnet main body 5 is a neodymium magnet of a compression-molded bonded magnet. However, the magnet main body 5 is not limited to this. The rare earth magnet is a permanent magnet made of a rare earth element (an element that belongs to the group 3 or lanthanoid except for actinium). The rare earth magnet includes a samarium cobalt magnet, a neodymium magnet, a terbium magnet, a dysprosium magnet, a praseodymium magnet, and a samarium iron nitrogen magnet. Also, the compression-molded bonded magnet is manufactured in such a way that a binding resin and magnet powders such as neodymium magnet powders are molded by pressing and then they are hardened by heating. Since the compression-molded bonded magnet is formed by hardening the magnet powders, the compression-molded bonded magnet is porous. The ultraviolet curing resin layer 7 is made of an ultraviolet curing resin. The ultraviolet curing resin layer 7 functions as a rust-proof film for the magnet main body 5.

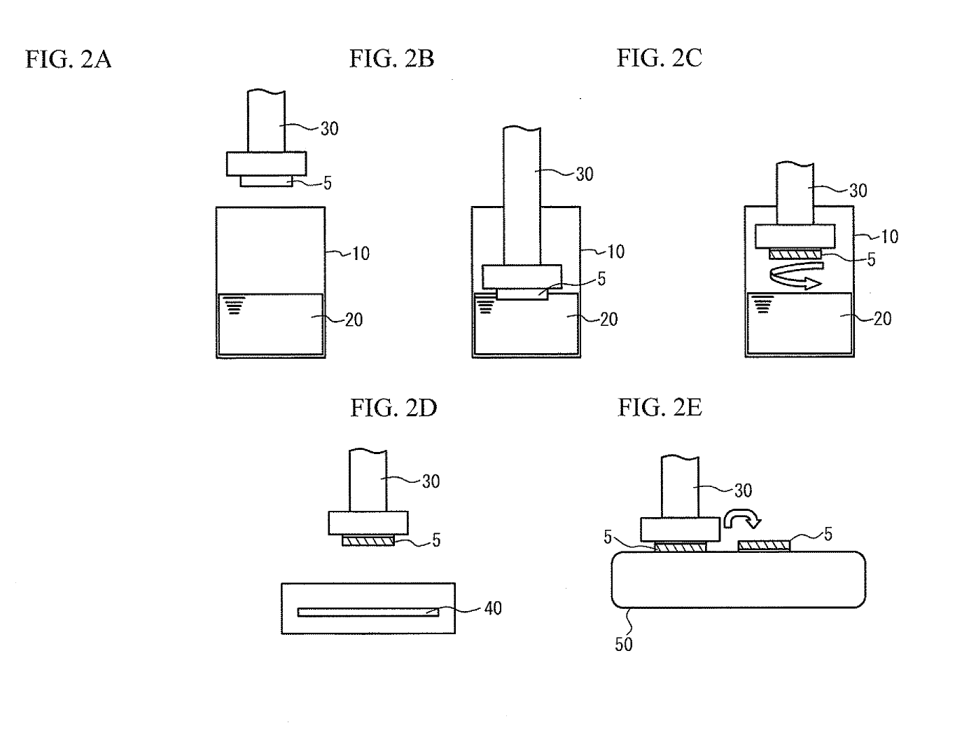

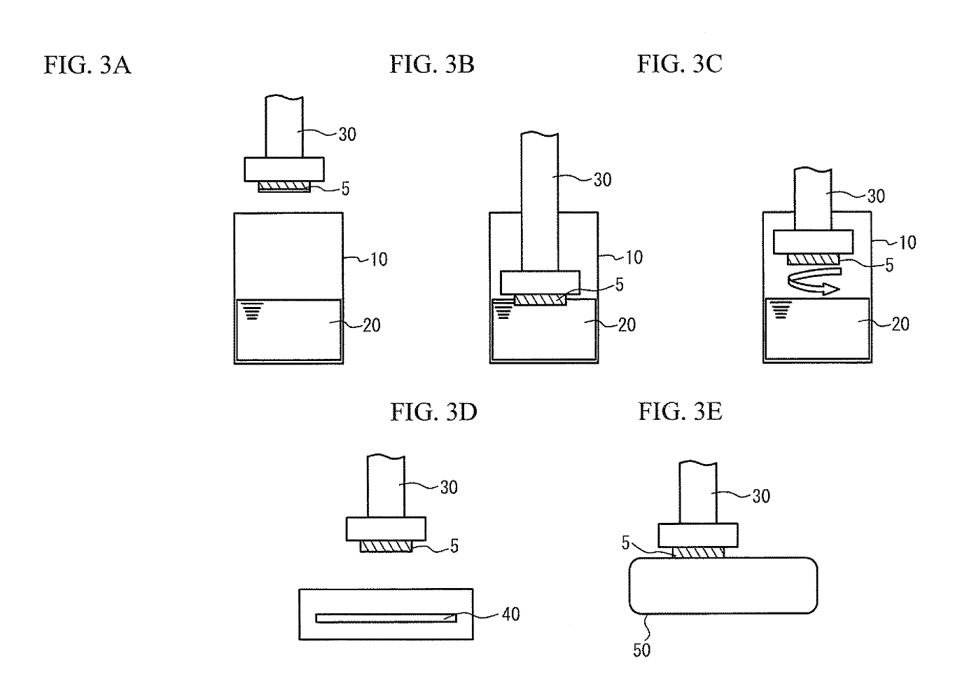

Next, a first example of the rust-proof treatment of the magnet will be described below. FIGS. 2A to 3E are explanatory views of the first example of rust-proof treatment of the magnet. As illustrated in FIG. 2A, an ultraviolet curing resin 20 is poured into a container 10, and an adsorption device 30 adsorbs the magnet main body 5. The adsorption device 30 has an built-in electromagnet, and the magnet main body 5 is adsorbed to the adsorption device 30 by the magnetic attraction force exerted between the electromagnet and the magnet main body 5. Additionally, the adsorption device 30 may adsorb the air to adsorb the magnet main body 5. The adsorption device 30 is capable of moving upward, downward, horizontally, and rotatably with plural motors. For example, the ultraviolet curing resin 20 is an ultraviolet curing type vinylester resin, but is not limited to this.

The adsorption device 30 moves downward to the ultraviolet curing resin 20 reserved in the container 10 with the adsorption device 30 adsorbing the magnet main body 5. Herein, only one side surface of the magnet main body 5 is soaked in the ultraviolet curing resin 20, but the magnet main body 5 is not wholly soaked in the ultraviolet curing resin 20, as illustrated in FIG. 2B. Specifically, a half degree of the thickness of the magnet main body 5 is soaked in the ultraviolet curing resin 20. If the magnet main body 5 is wholly soaked in the ultraviolet curing resin 20, the ultraviolet curing resin 20 may also be applied between the magnet main body 5 and an adsorption surface of the adsorption device 30. Therefore, the magnet main body 5 may be fixed to the adsorption device 30 when the ultraviolet curing resin 20 is cured as will be described later. Thus, the adsorption device 30 has to stop, after the adsorption device 30 moves downward before the whole magnet main body 5 is soaked in the ultraviolet curing resin 20. The stop position of the adsorption device 30 can be controlled based on output signals from a sensor detecting a height level of the liquid surface of the ultraviolet curing resin 20. When the magnet main body 5 is soaked in the ultraviolet curing resin 20, the height level of the liquid surface of the ultraviolet curing resin 20 rises. The sensor detects the rising degree of the liquid surface to determine how much the magnet main body 5 is soaked in the ultraviolet curing resin 20. This principle ensures the accuracy of the stop position of the adsorption device 30.

Additionally, the container 10 may be depressurized while the magnet main body 5 is being soaked in the ultraviolet curing resin 20. As mentioned above, the magnet main body 5 is the compression-molded bonded magnet and porous. Thus, the container 10 is depressurized, thereby releasing air within the magnet main body 5 to the outside. It is therefore possible to sufficiently percolate the ultraviolet curing resin 20 through the magnet main body 5. Additionally, the container 10 is depressurized by a vacuum pump or the like.

Next, as illustrated in FIG. 2C, the adsorption device 30 moves upward to detach the magnet main body 5 from the liquid surface of the ultraviolet curing resin 20, and then stops in the container 10. Next, the adsorption device 30 rotates in the container 10. It is therefore possible to remove an excess ultraviolet curing resin 20 applied on the surface of the magnet main body 5. Further, the scattered excess ultraviolet curing resin 20 from the surface of the magnet main body 5 is recollected by the container 10 again. This saves the consumption of the ultraviolet curing resin 20.

Next, the adsorption device 30 moves above an ultraviolet radiation device 40, as illustrated in FIG. 2D. The ultraviolet radiation device 40 radiates ultraviolet rays to the magnet main body 5 to cure the ultraviolet curing resin 20 applied thereto. The rust-proof treatment for one side of the magnet main body 5 is accomplished in this way.

Next, as illustrated in FIG. 2E, the adsorption device 30 moves above a belt conveyor 50, and then the energization of the electromagnet of the adsorption device 30 is cut off to put the magnet main body 5 on the belt conveyor 50. An operator reverses the magnet main body 5 put on the belt conveyor 50, and the electromagnet of the adsorption device 30 is energized to adsorb the reversed magnet main body 5 again.

Next, the rust-proof treatment of the back side of the magnet main body 5 is performed in the same method. As illustrated in FIGS. 3A to 3C, the back side of the magnet main body 5 is soaked in the ultraviolet curing resin 20, and the magnet main body 5 is detached from the ultraviolet curing resin 20 to remove the excess ultraviolet curing resin 20 applied to the magnet main body 5. The ultraviolet curing resin 20 of the back side of the magnet main body 5 is cured by the ultraviolet radiation device 40 as illustrated in FIG. 3D, and then the magnet main body 5 is put on the belt conveyor 50 as illustrated in FIG. 3E.

The magnet 1 where the magnet main body 5 is treated by the rust-proof treatment is accomplished in this way. Since the rust-proof treatment is performed by use of the ultraviolet curing resin 20 as mentioned above, the period for the curing is shorter than a case of using a thermosetting resin. For this reason, the power consumption by lighting the ultraviolet radiation device 40 is less than the power consumption of a heat-treatment furnace used for curing the thermosetting resin. This reduces the cost of the rust-proof treatment.

For example, the plating treatment uses a harmful solvent. Thus, such a solvent has to be managed strictly. However, it is easy to manage the ultraviolet curing resin, and the ultraviolet curing resin is hardly influenced by a change in the viscosity caused by volatilization. Further, as for the management of the ultraviolet curing resin, if only the temperature management is appropriate at a dark place to which the ultraviolet rays are not radiated, the state of the ultraviolet curing resin is rarely changed.

Also, since the magnet main body 5 is the compression-molded bonded magnet as stated above, the magnet main body 5 is porous. Thus, in a case where the rust-proof treatment of the magnet main body 5 is performed by the electrodeposition coating, the air remaining in bores may be released to the outside during coating, so that there may be a part not be coated. In the present embodiment, the container 10 can be depressurized by the vacuum pump or the like. Thus, the ultraviolet curing resin can be sufficiently percolated into the magnet main body 5, and the above problem can be overcome.

In the case of the powder coating and the spray coating, it may be difficult to uniformly apply coatings on the surface of the magnet main body 5. In the present embodiment, the adsorption device 30 rotates after the magnet main body 5 is soaked in the ultraviolet curing resin 20. It is therefore possible to remove the excess ultraviolet curing resin 20 from the magnet main body 5. Also, in the case of the powder coating and the spray coating, since a large amount of the coating is spread while being coated, a large exhaust or ventilation facilities are needed. In the case where the rust-proof treatment is performed by use of the ultraviolet curing resin in the present embodiment, such an exhaust or ventilation facilities is no longer necessary.

The rust-proof treatment of the magnet main body is performed at a low cost in the soaking method using the ultraviolet curing resin in such a way.

Additionally, it is conceivable to perform the conventional electrodeposition coating of the ultraviolet curing resin to the magnet main body 5. In this case, the coatings are deposited on the surface of the magnet main body 5 in the electrodeposition process in a first step. In a second step, it is washed with water. In a third step, water within the coating film is heated and dried. In a fourth step, the ultraviolet rays are irradiated by the radiation device to obtain the rust-proof film. However, this electrodeposition coating method requires the electricity and operation period more than those of the present embodiment. Further, in a case where the magnet main body 5 is porous like the present embodiment, water may remain in the bores to generate rust. This is because the drying step of the third step originally has a purpose of drying the moisture content of the coated film. If the temperature or the operation period in the drying step is adjusted such that the water does not remain within the coating film, both the operation period and the power consumption further increase, and then costs increase.

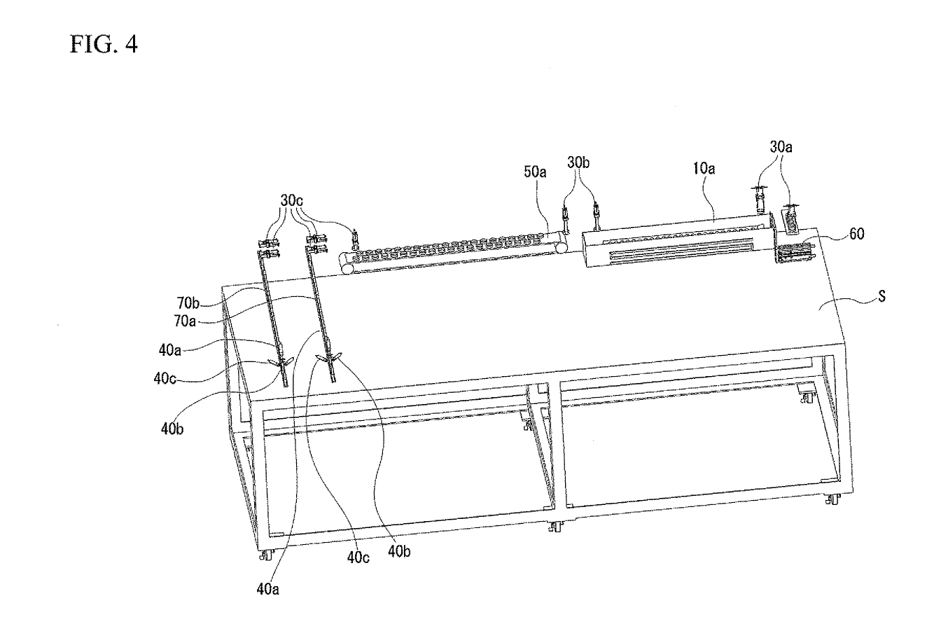

Next, a second example of the rust-proof treatment of the magnet will be described below. FIGS. 4 to 11 are explanatory views of the second example of the rust-proof treatment of the magnet. Additionally, the similar reference numerals to the first example of the rust-proof treatment of the magnet are given to omit duplicated explanation. FIG. 4 illustrates a whole apparatus for performing the rust-proof treatment.

This apparatus includes: a stage S; a container 10a; hands 30a to 30c; a belt conveyor 50a; a pushing cylinder 60, and rail portions 70a and 70b. The magnet main body 5 is transported from the container 10a to the belt conveyor 50a, and the rail portions 70a and 70b in this order, and then a magnet 1a treated by the rust-proof treatment is accomplished. The hands 30a to 30c are respectively secured to ends of the robot arms different from one another, and are capable of grasping and releasing a magnet main body 5a. The magnet main body 5a can be moved to the desired position by driving an arm portion of the robot arm.

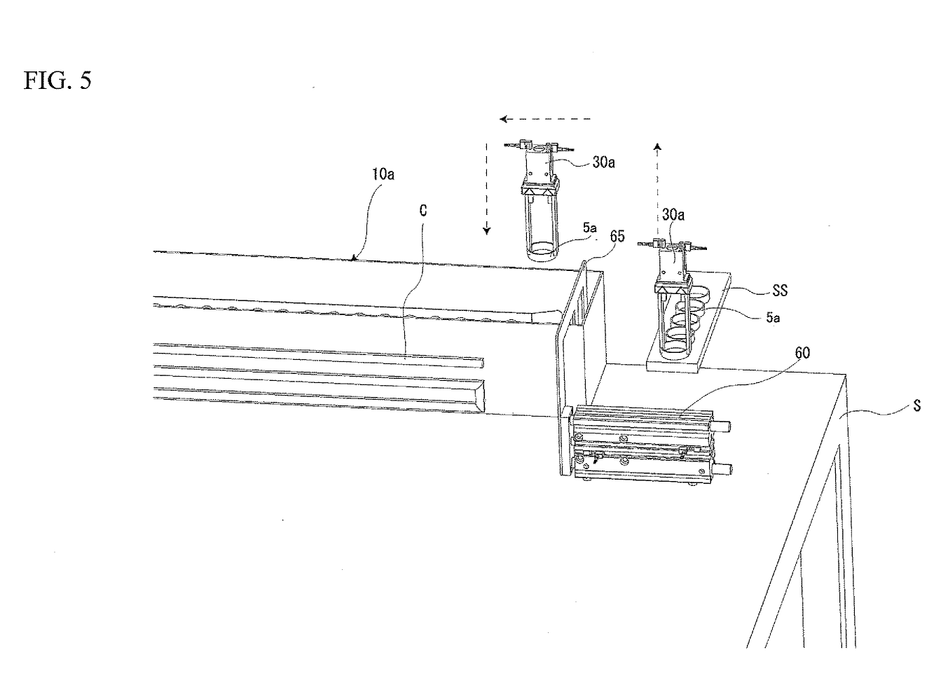

As illustrated in FIG. 5, the hand 30a grasps the magnet main body 5a put on a support plate SS, and moves in the direction of an arrow to put the magnet main body 5a within the container 10a. The support plate SS having a plate shape is secured to a surface of the stage S.

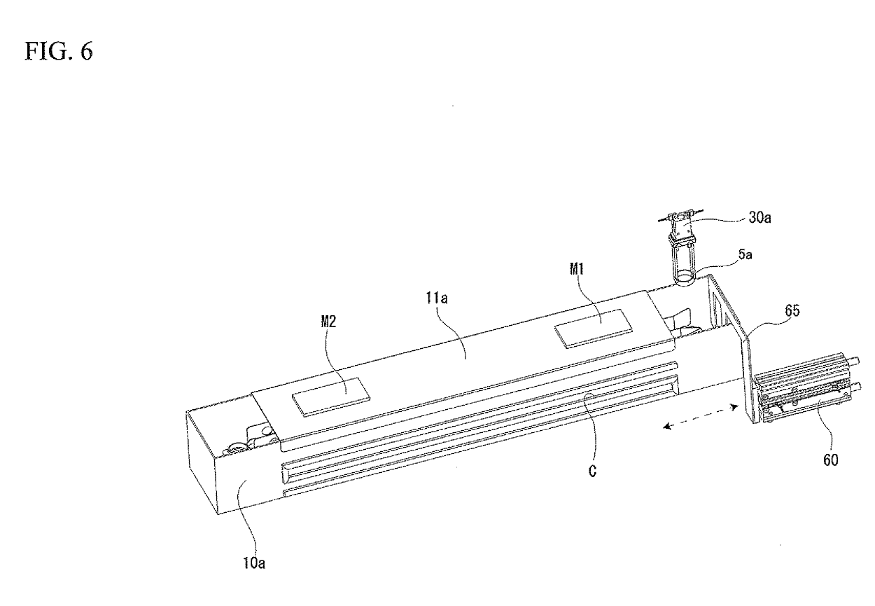

As illustrated in FIG. 6, the container 10a is attached with a cover 11a. The cover 11a is secured with a liquid level meter M1 and a viscometer M2 for respectively measuring a liquid height level and a viscosity of the ultraviolet curing resin retained in the container 10a. Also, a cooling pipe C is secured to the side of the container 10a. The cooling pipe C is connected to a chiller unit not illustrated. The cooling pipe C suppresses a change in the temperature of the ultraviolet curing resin in the container 10a.

The pushing cylinder 60 is arranged at the front side of the container 10a. The pushing cylinder 60 is equipped with a pushing piece 65 which moves in a predetermined range in a lengthwise direction of the container 10 in response to the force of an actuator. For example, the pushing piece 65 having a thin plate shape is made of metal. A rear end of the pushing piece 65 is secured to the main body of the pushing cylinder 60, and a front end of the pushing piece 65 extends to the container 10a. The hand 30a puts the magnet main body 5a on the front end side within the container 10a.

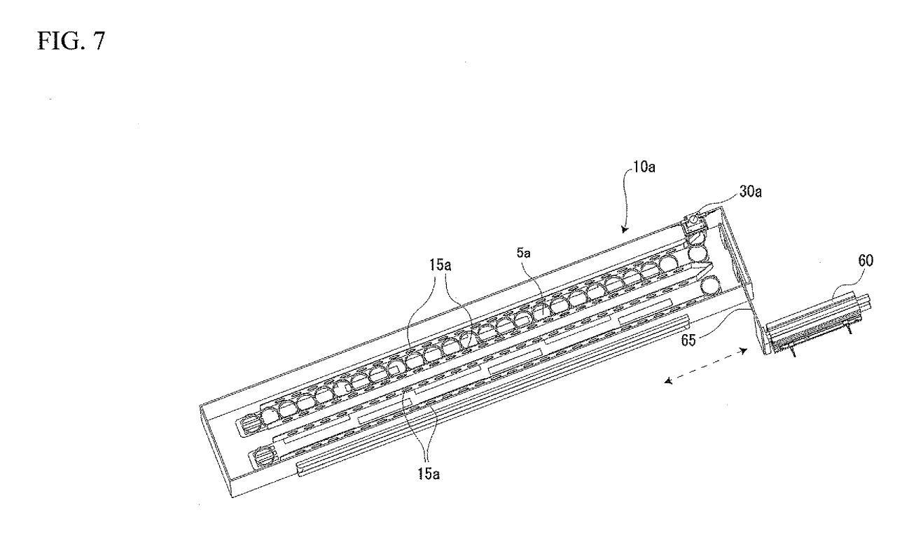

FIG. 7 illustrates the inside of the container 10a. The magnet main body 5a put on the front end side within the container 10a by the hand 30a is pushed to the rear end of the container 10a by the reciprocating movement of the pushing piece 65. Within the container 10a, four guide rails 15a are arranged and extend in the lengthwise direction of the container 10a. The plural magnet main bodies 5a aligned in two lines pushed by the pushing piece 65 move to the rear end side of the container 10a. In such a way, the magnet main body 5a moves within the container 10a with soaked in the ultraviolet curing resin.

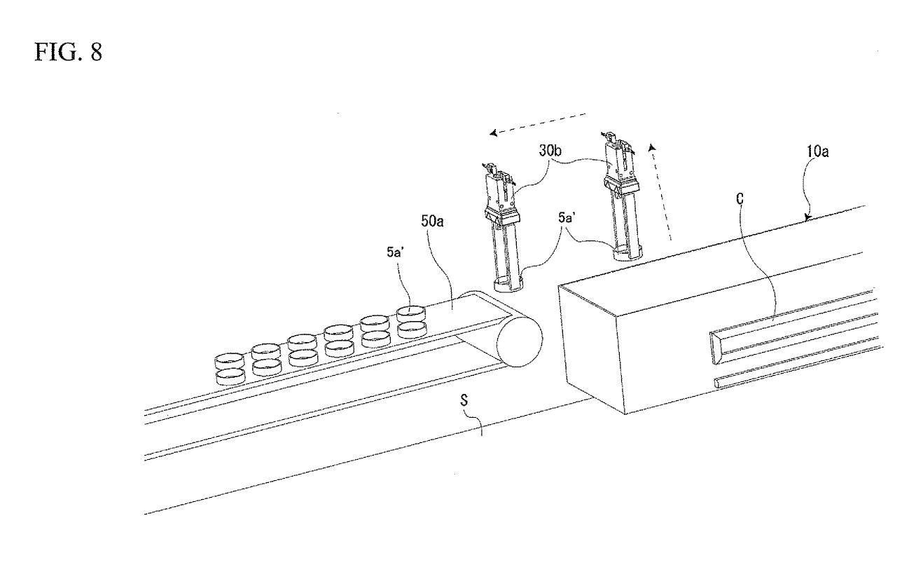

The magnet main body 5a reaching the rear end of the container 10a is taken out of the container 10a by the hand 30b as illustrated in FIG. 8. The hand 30b stops between the container 10a and the belt conveyor 50a for a predetermined period with grasping a magnet main body 5a′. This is because the thickness of the ultraviolet curing resin applied to the magnet main body 5a′ is made uniform. Additionally, a fan may send air to the magnet main body 5a′ taken out of the container 10a. Further, the ultraviolet rays may be radiated to the magnet main body 5a′ taken out of the container 10a. In addition, the magnet main body 5a′ means the magnet main body 5a applied with the ultraviolet curing resin which is not sufficiently cured.

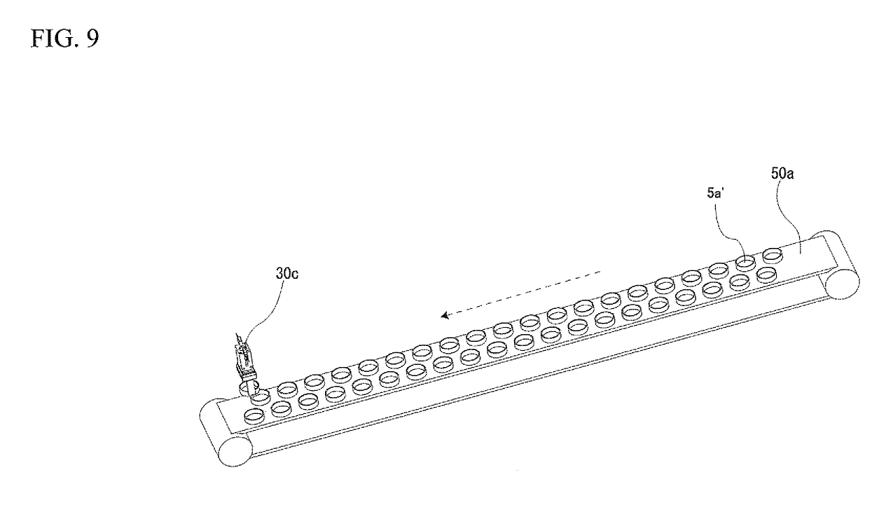

Next, the hand 30a puts the magnet main body 5a′ on a front end of the belt conveyor 50a as illustrated in FIG. 9, and then the magnet main body 5a′ can be transported by the belt conveyor 50a in the direction of an arrow for a predetermined period. The belt conveyor 50a is supported by a wall portion not illustrated. Additionally, the ultraviolet rays may be radiated to the magnet main body 5a′ which is being transported by the belt conveyor 50a. For example, a radiation head may be provided, above the belt conveyor 50a, for radiating the ultraviolet rays to the magnet main body 5a′ which is being transported by the belt conveyor 50a.

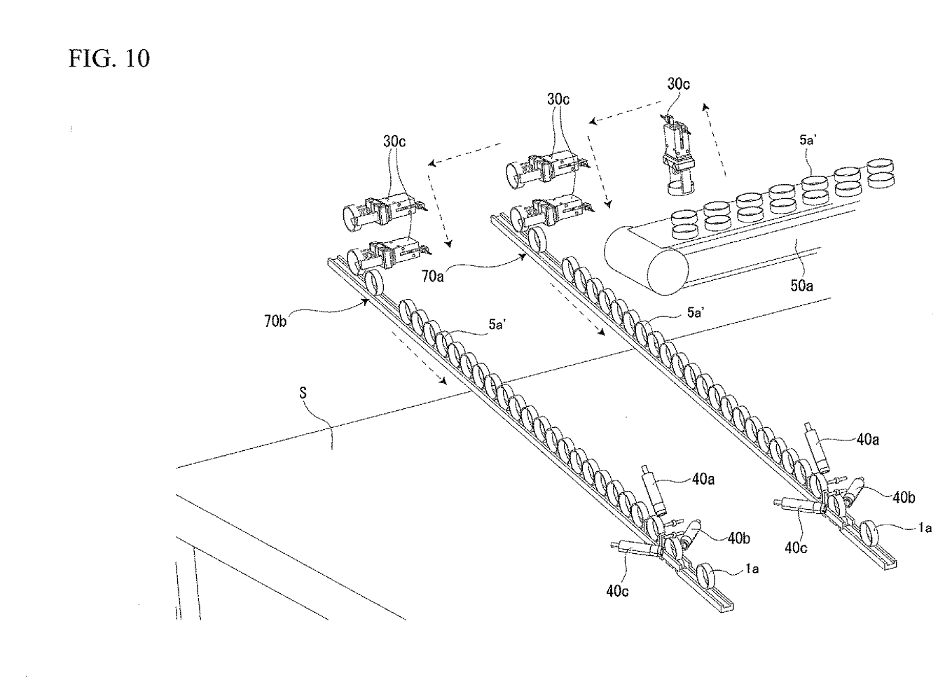

The magnet main body 5a′ reaching a rear end of the belt conveyor 50a is lifted up by the hand 30c, and then is put on a front end side of the rail portion 70a or 70b as illustrated in FIG. 10. At this time, the hand 30c puts the magnet main body 5a′ in the vertical posture on the rail portion 70a or 70b. The hand 30c puts the plural magnet main bodies 5a′ transported by the belt conveyor 50a on the rail portion 70a or 70b alternately. The rail portion 70a slants relative to the horizontal line such that its front end side is positioned upper than its rear end side. Thus, the magnet main body 5a′ in the vertical posture put on the rail portion 70a rolls to the rear end side of the rail portion 70a in accordance with the weight of the magnet main body 5a′. This applies to the rail portion 70b.

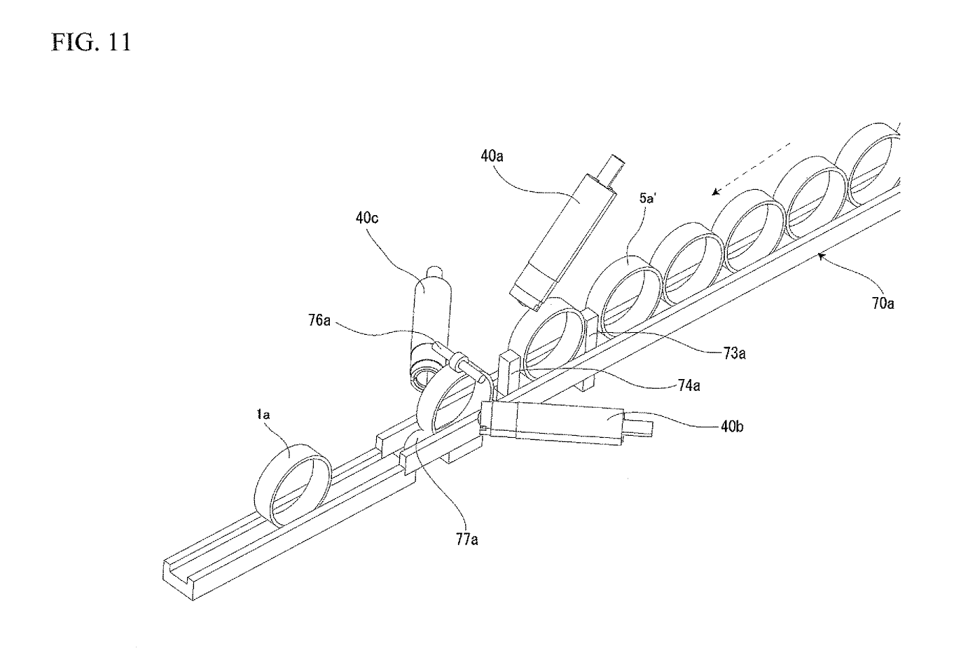

Stoppers 73a and 74a are provided at the front end side of the rail portion 70a as illustrated in FIGS. 10 and 11. The stoppers 73a and 74a are capable of advancing and retreating through openings formed in a bottom surface of the rail portion 70a, respectively. The stoppers 73a and 74a are driven by the power from actuators not illustrated at a predetermined timing. The stoppers 73a and 74a hold and separate one of the plural magnet main bodies 58′ abutting each other and aligned on the rail portion 70a from the other magnet main bodies 5a′. A distance between the stoppers 73a and 74a is substantially the same as an outer diameter of the magnet main body 5a′.

The stopper 73a retreats from the bottom surface of the rail portion 70a and the stopper 74a protrudes therefrom, whereby the stopper 74a stops the magnet main body 5a′ rolling from an upstream side. In this state, the stopper 73a protrudes from the bottom surface of the rail portion 70a, whereby this magnet main body 5a′ is separated from the following magnet main body 5a′. The magnet main body 5a′ held between the stoppers 73a and 74a rolls to the downstream side, when the stopper 74a moves downward relative to the bottom surface of the rail portion 70a and recedes from the magnet main body 5a′. After that, the stopper 74a protrudes from the bottom surface of the rail portion 70a again and the stopper 73a recedes from the bottom surface of the rail portion 70a. Therefore, the following other magnet main body 5a′ is held between the stoppers 73a and 74a.

Three radiation heads 40a to 40c, a driving roller 76a, and a driven roller 77a are arranged in the downstream side of the stoppers 73a and 74a. The radiation heads 40a to 40c are supported by a housing or a wall provided around the rail portion 70a. Likewise, the driving roller 76a is rotatably supported by them. The driving roller 76a rotates in response to the force of an actuator not illustrated. The driven roller 77a partially protrudes from an opening formed in the bottom surface of the rail portion 70a. The driven roller 77a is rotatable, but is not connected to a power source. The driving roller 76a and the driven roller 77a are supported to be movable between the position where they abut the magnet main body 5a′ and the position where they are spaced apart from the magnet main body 5a′.

The magnet main body 5a′ rolled to the downstream side of the stopper 74a abuts the driving roller 76a and the driven roller 77a and its movement is restricted. When the driving roller 76a rotates with the magnet main body 5a′ abutting the driving roller 76a and the driven roller 77a, in response to this, the magnet main body 5a′ rotates, and then the driven roller 77a also rotates in response to the magnet main body 5a′. The magnet main body 5a′ is forcibly rotated in this way.

The radiation heads 40a to 40c radiate the ultraviolet rays to the rotating magnet main body 5a′. The radiation head 40a mainly radiates the ultraviolet rays to an outer circumferential surface of the magnet main body 5a′. The radiation heads 40b and 40c are arranged to sandwich the magnet main body 5a′, and mainly radiate the ultraviolet rays to an inner circumferential surface of the magnet main body 5a′. The ultraviolet rays are radiated while the magnet main body 5a′ is rotating for a predetermined period in this way. It is therefore possible to sufficiently cure the ultraviolet curing resin applied to the magnet main body 5a′. After a predetermined period, the driving roller 76a and the driven roller 77a recede from the magnet main body 5a′, whereby the magnet 1a rolls to the rear end of the rail portion 70a in accordance with the weight of the magnet 1a itself. This obtains the magnet 1a treated by the rust-proof treatment. Repeating the above processes accomplish plural magnets 1a.

Since the second example of the rust-proof treatment is also performed by use of the ultraviolet curing resin 20 as mentioned above, the period for the curing is shorter than a case of using a thermosetting resin. Thus, the cost of the rust-proof treatment is reduced. The rust-proof treatment can be performed without heating the magnet main body 5a in such a way.

Also, in the second example of the rust-proof treatment, the magnet main body 5a′ is changed into the vertical posture from the horizontal posture, and the magnet main body 5a′ rolls on the rail portion 70a or 70b as mentioned above. It is therefore possible to sufficiently percolate the ultraviolet curing resin into the magnet main body 5a″.

As mentioned above, the magnet is rotated by the driving roller 76a or the like, the magnet main body may have any shape as long as it is rotatable. For example, the magnet main body may have a disc shape or a column shape.

The ultraviolet curing resin used in the first and second examples of the rust-proof treatment has only to have a low viscosity and three or more functional groups. For example, the ultraviolet curing resin is Propoxylated3 Trimethylolpropane Triacrylate or Petaerythritol Triacrylate, but is not limited to them.

The two rail portions 70a and 70b are used in the second example of the rust-proof treatment, but the number thereof may be three or more.

While the exemplary embodiments of the present invention have been illustrated in detail, the present invention is not limited to the above-mentioned embodiments, and other embodiments, variations and modifications may be made without departing from the scope of the present invention.

What is claimed is:

1. A magnet comprising:
a magnet main body; and
an ultraviolet curing resin layer formed on a surface of the magnet main body.

2. The magnet of claim 1, wherein the magnet main body is a rare earth magnet.

3. The magnet of claim 1, wherein the magnet main body is a neodymium magnet.

4. The magnet of claim 1, wherein the magnet main body is a compression-molded bonded magnet.

5. The magnet of claim 1, wherein the magnet main body is porous.

6. A method of manufacturing a magnet comprising:
applying an ultraviolet curing resin on a magnet main body; and
radiating an ultraviolet ray to the ultraviolet curing resin.

7. The method of manufacturing a magnet of claim 6, wherein the ultraviolet ray is radiated to the ultraviolet curing resin while the magnet main body is being rotated.
